(19) United States
(12) Patent Application Publication
(10) Pub. No.: US 2020/0335057 A1
(43) Pub. Date: Oct. 22, 2020

(54) LIQUID CRYSTAL DISPLAY DEVICE

(71) Applicant: Samsung Display Co., Ltd., Yongin-si (KR)

(72) Inventors: Se Hyun LEE, Hwaseong-si (KR); Hak Sun CHANG, Yongin-si (KR); Dong Hwan KIM, Hwaseong-si (KR)

(21) Appl. No.: 16/737,833

(22) Filed: Jan. 8, 2020

(30) Foreign Application Priority Data
Apr. 18, 2019 (KR) 10-2019-0045421

(51) Int. Cl. G09G 3/36; G02F 1/1362

(52) U.S. Cl. CPC G09G 3/3688; G02F 1/136209; G09G 3/3696

(57) ABSTRACT

A display device including a gate line disposed on a substrate, a first data line and a second line crossing the gate line, a first transistor electrically connected with the gate line and the first data line, a second transistor electrically connected with the gate line and the second data line, a first pixel electrode electrically connected with the first transistor, and a second pixel electrode electrically connected with the second transistor and overlapping the first pixel electrode along an extension direction of the gate line, in which the first and second pixel electrodes include a horizontal stem portion, a vertical stem portion, and a minute branch portion, and a first angle formed by the first horizontal stem portion and the first minute branch portion is smaller than a second angle formed by the second horizontal stem portion and the second minute branch portion.

### CROSS-REFERENCE TO RELATED APPLICATION

This application claims priority from and the benefit of Korean Patent Application No. 10-2019-0045421, filed on Apr. 18, 2019, which is hereby incorporated by reference for all purposes as if fully set forth herein.

### BACKGROUND

### Field

Exemplary embodiments of the invention relate generally to a display device.

### Discussion of the Background

A liquid crystal display, which is one of the most widely used flat panel displays at present, includes two substrates including field generating electrodes such as a pixel electrode and a common electrode, and a liquid crystal layer interposed therebetween.

The liquid crystal display forms an electric field in the liquid crystal layer by applying a voltage to the field generating electrodes, and controls polarization of incident light with the electric field to display an image.

The above information disclosed in this Background section is only for understanding of the background of the inventive concepts, and, therefore, it may contain information that does not constitute prior art.

### SUMMARY

Display devices constructed according to exemplary implementations of the invention have improved side visibility and transmittance.

Additional features of the inventive concepts will be set forth in the description which follows, and in part will be apparent from the description, or may be learned by practice of the inventive concepts.

A display device according to an exemplary embodiment includes a gate line disposed on a substrate, a first data line and a second line crossing the gate line, a first transistor electrically connected with the gate line and the first data line, a second transistor electrically connected with the gate line and the second data line, a first pixel electrode electrically connected with the first transistor, and a second pixel electrode electrically connected with the second transistor and overlapping the first pixel electrode along an extension direction of the gate line, in which the first pixel electrode includes a first horizontal stem portion, a first vertical stem portion perpendicularly crossing the first horizontal stem portion, and a first minute branch portion extending from the first horizontal stem portion and the first horizontal stem portion, the second pixel electrode includes a second horizontal stem portion, a second vertical stem portion perpendicularly crossing the second horizontal stem portion, and a second minute branch portion extending from the second horizontal stem portion and the second vertical stem portion, and a first angle formed by the first horizontal stem portion and the first minute branch portion is smaller than a second angle formed by the second horizontal stem portion and the second minute branch portion.

The first angle may be about 38° to about 40°.

The second angle may be about 41° to about 45°.

The display device may further include a third pixel electrode and a fourth pixel electrode, in which the third pixel electrode may include a third horizontal stem portion, a third vertical stem portion, and a third minute branch portion, the fourth pixel electrode may include a fourth horizontal stem portion, a fourth vertical stem portion, and a fourth minute branch portion, the third horizontal stem portion and the third minute branch portion may form a third angle greater than the second angle, and the fourth horizontal stem portion and the fourth minute branch portion may form a fourth angle greater than the third angle.

The first pixel electrode may be configured to be applied with a first voltage, the second pixel electrode may be configured to be applied with a second voltage less than the first voltage, the third pixel electrode may be configured to be applied with a third voltage less than the second voltage, and the fourth pixel electrode may be configured to be applied with a fourth electrode less than the third voltage.

The first pixel electrode may be configured to be applied with a first voltage, and the second pixel electrode may be configured to be applied with a second voltage less than the first voltage.

An area occupied by the first pixel electrode and an area occupied by the second pixel electrode may be substantially the same.

The display device may further include a light blocking layer disposed on the same layer as the gate line and overlapping the first vertical stem portion.

The first pixel electrode may include a first slit disposed between the first minute branch portions, a width of the first minute branch portion may be about 3.0 micrometers to about 3.6 micrometers, and a width of the first slit may be about 2.4 micrometers to about 3.0 micrometers.

A width of the first minute branch portion may be less than a width of the second minute branch portion.

A display device according to another exemplary embodiment includes a gate line disposed on a substrate, a first data line and a second data line crossing the gate line, a first transistor electrically connected with the gate line and the first data line, a second transistor electrically connected with the gate line and the second data line, a first pixel electrode electrically connected with the first transistor, and a second pixel electrode electrically connected with the second transistor, in which the first pixel electrode includes a first horizontal stem portion, a first vertical stem portion perpendicularly crossing the first horizontal stem portion, and a first minute branch portion extending from the first horizontal stem portion and the first vertical stem portion, the second pixel electrode includes a second horizontal stem portion, a second vertical stem portion perpendicularly crossing the second horizontal stem portion, and a second minute branch portion extending from the second horizontal stem portion and the second vertical minute branch portion, a planar area of the first pixel electrode and a planar area of the second pixel electrode are substantially the same, and a first angle formed by the first horizontal stem portion and the first minute branch portion is smaller than a second angle formed by the second horizontal stem portion and the second minute branch portion.

The first pixel electrode may be configured to be applied with a first voltage, and the second pixel electrode may be configured to be applied with a second voltage less than the first voltage.

The first angle may be about 38° to about 40°.

The second angle may be about 41° to about 45°.

The display device may further include a light blocking layer disposed on the same layer as the gate line and overlapping the first vertical stem portion.

The second vertical stem portion may not overlap the light blocking layer.

A width of the first minute branch portion may be less than a width of the second minute branch portion.

The first pixel electrode may include a first slit disposed between the first minute branch portions, the second pixel electrode may include a second slit disposed between the second minute branch portions, and a width of the first slit may be greater than a width of the second slit.

The display device may further include a third pixel electrode and a fourth pixel electrode, in which the third pixel electrode may include a third horizontal stem portion, a third vertical stem portion, and a third minute branch portion, the fourth pixel electrode may include a fourth horizontal stem portion, a fourth vertical stem portion, and a fourth minute branch portion, the third horizontal stem portion and the third minute branch portion may form a third angle greater than the second angle, and the fourth horizontal stem portion and the fourth minute branch portion may form a fourth angle greater than the third angle.

The first pixel electrode may be configured to be applied with a first voltage, the second pixel electrode may be configured to be applied with a second voltage less than the first voltage, the third pixel electrode may be configured to be applied with a third voltage less than the second voltage, and the fourth pixel electrode may be configured to be applied with a fourth electrode less than the third voltage.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a schematic top plan view of a portion of a display device according to an exemplary embodiment.

FIG. 2 is a top plan view of a pixel in an area A of FIG. 1.

FIG. 3 is a cross-sectional view taken along line of FIG. 2.

FIG. 4 is a top plan view of two adjacent pixels in an area B of FIG. 1.

FIG. 5 is a top plan view of two pixels according to an exemplary embodiment.

FIG. 6 is a top plan view of two pixels according to an exemplary embodiment.

FIG. 7 is a schematic top plan view of a portion of a display according to an exemplary embodiment.

FIG. 8 is a top plan view of a plurality of pixels in an area C of FIG. 7.

FIG. 9 is a graph that shows transmittance and GDI according to an angle formed by a horizontal stem portion and a minute branch portion.

FIG. 10 is a graph showing gamma curves according to grayscales of an exemplary embodiment, in which an angle formed by a horizontal stem portion and a minute branch portion is changed.

FIG. 11 is a graph showing gamma curves with respect to an exemplary embodiment and a comparative example including a light blocking layer.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

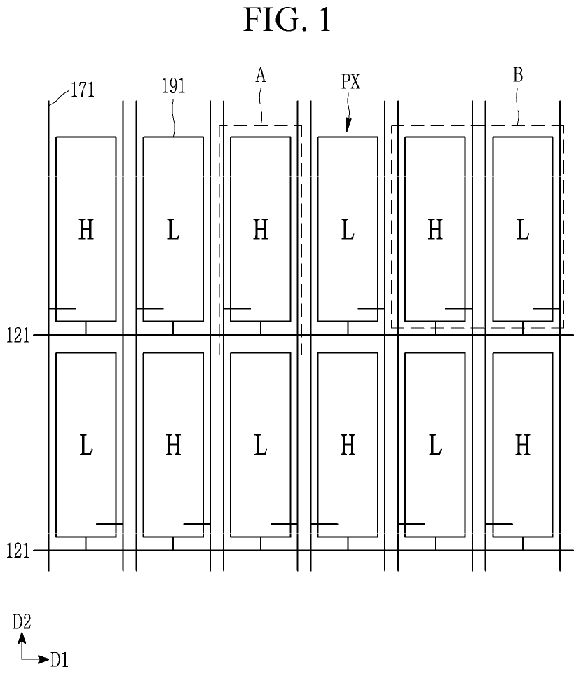

Hereinafter, a display device according to an exemplary embodiment will be described with reference to FIG. 1. FIG. 1 is a schematic top plan view of a portion of a display device according to an exemplary embodiment.

Referring to FIG. 1, a display device according to an exemplary embodiment may include a plurality of pixels PX arranged in a matrix format.

Each pixel PX may include a transistor and a pixel electrode 191 that are connected to a gate line 121 and a data line 171. Each pixel may include a transistor and a liquid crystal capacitor.

In the display device according to an exemplary embodiment, the plurality of pixels PX located in an n^{th} column may be alternatively connected with data lines 171 that are disposed at opposite sides thereof. For example, a pixel PX located in the first row of the n^{th} column is connected with a data line 171 disposed at the left side of the pixel PX, and a pixel PX located in the second row of the n^{th} column is connected with a data line 171 disposed in the right side of the pixel PX, and such connection configuration may be repeated. In this manner, odd-numbered pixels PX and even-numbered pixels PX included in one column are connected with different data lines 171. A single gate line 121 may be connected with each of the pixels PX in one row.

Pixel electrodes 191 included in a plurality of pixels PX that are located in one column may receive different voltages. For example, a pixel electrode 191 located in the first row in the n^{th} column may receive a first voltage, and a pixel electrode 191 located in the second row in the n^{th} column may receive a second voltage lower than the first voltage. In FIG. 1, pixels receiving a relatively high voltage are indicated as “H” and pixels receiving a relatively low voltage are indicated as “L”. Pixels H receiving the first voltage and pixels L receiving the second voltage may be repeatedly disposed along a second direction D2.

Alternatively, the pixels H receiving the first voltage and the pixels L receiving the second voltage may be repeatedly disposed along a first direction D1. A plurality of pixels PX connected to the same gate line 121 may include pixels H receiving the first voltage and pixels L receiving the second voltage along the first direction D1.

However, the inventive concepts are not limited thereto. For example, in some exemplary embodiments, the pixels H receiving the first voltage and the pixels L receiving the second voltage may have various alignment formats by controlling a voltage applied to the data line 171, and thus, the arrangement of the pixels are not limited to that shown in FIG. 1.

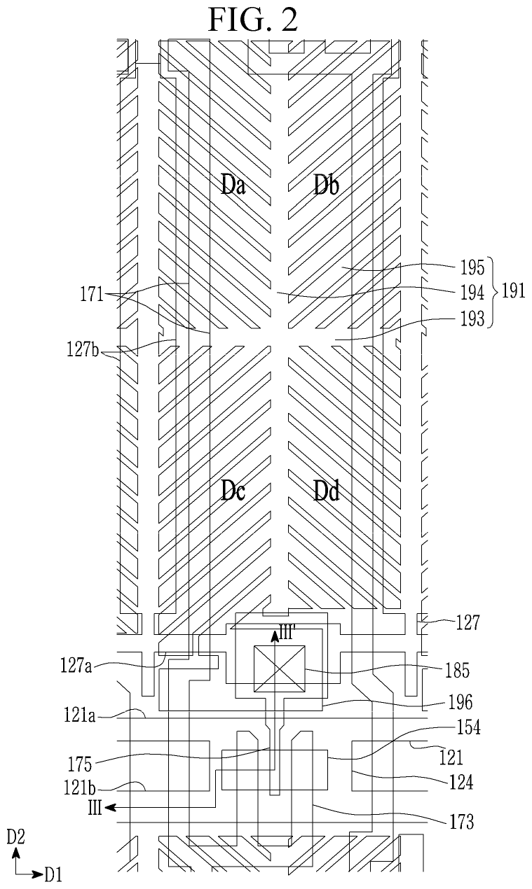

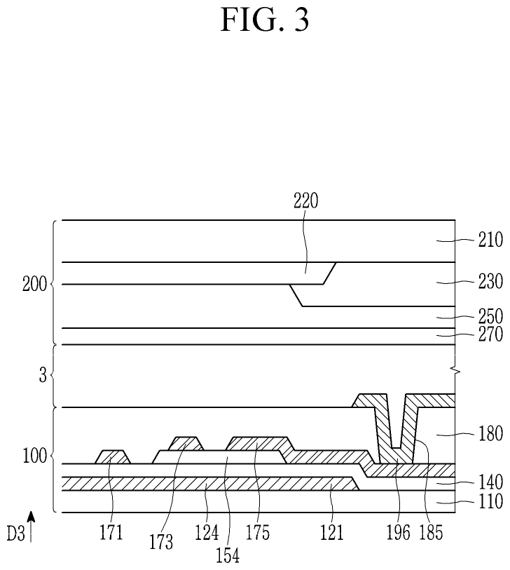

Hereinafter, a structure of a pixel according to an exemplary embodiment will be described with reference to FIG. 2 and FIG. 3. FIG. 2 is a top plan view of a pixel in an area A of FIG. 1, and FIG. 3 is a cross-sectional view taken along line of FIG. 2.

Referring to FIGS. 2 and 3, a lower panel 100 will be first described. The display device according to an exemplary embodiment includes the gate line 121 disposed on a substrate 110, which may include transparent glass or plastic.

The gate line 121 transmits a gate signal and extends in the first direction D1. The gate line 121 includes a gate electrode 124 protruded therefrom.

The gate line 121 according to the illustrated exemplary embodiment may include a first auxiliary gate line 121a and second auxiliary gate line 121b. The first auxiliary gate line 121a and the second auxiliary gate line 121b may be connected with each other through the gate electrode 124. The gate electrode 124 may be connected with the first auxiliary gate line 121a and the second auxiliary gate line 121b, respectively. The gate electrode 124 may protrude from the first auxiliary gate line 121a, or may protrude from the second auxiliary gate line 121b. In this manner, even if one of the first auxiliary gate line 121a and the second auxiliary gate line 121b is disconnected, a gate signal can be stably transmitted.

In addition, a storage electrode line 127 may be disposed on the same layer as the gate line 121. The storage electrode line 127 may include a horizontal portion 127a extending in the first direction D1 and a vertical portion 127b extending in the second direction D2. The vertical portion 127b may be disposed between adjacent pixel electrodes 191, and may be substantially parallel with the data line 171.

A gate insulating layer 140 may include an insulation material, such as a silicon oxide or a silicon nitride, and may be disposed on the gate line 121 and the storage electrode line 127. The gate insulating layer 140 may have a multilayer structure including at least two insulation layers, each having a single-layered structure or a different physical property.

A semiconductor layer 154 is disposed on the gate insulating layer 140. The semiconductor layer 154 may overlap the gate electrode 124.

Next, the data line 171, a source electrode 173, and a drain electrode 175 are disposed on the semiconductor layer 154 and the gate insulating layer 140. The source electrode 173 and the drain electrode 175 are connected with the data line 171.

The data line 171 transmits a data signal and extends in the second direction D2, and crosses the gate line 121. The source electrode 173 extends from the data line 171 and overlaps the gate electrode 124, and may have substantially a shape of “U”. The drain electrode 175 is separated from the data line 171, and may extend upward from a center of the U-shaped source electrode 173.

One gate electrode 124, one source electrode 173, and one drain electrode 175 form one transistor (TFT) together with the semiconductor layer 154, and a channel region of the transistor is formed in the semiconductor layer 154 between the source electrode 173 and the drain electrode 175.

Next, an insulation layer 180 is disposed on the data line 171, the source electrode 173, and the drain electrode 175. The insulation layer 180 may include an inorganic insulation material, such as a silicon nitride or a silicon oxide, an organic insulation material, or a low-dielectric insulation material.

The insulation layer 180 includes a contact hole 185 that overlaps the drain electrode 175. The pixel electrode 191 is physically and electrically connected with the drain electrode 175 through the contact hole 185, and receives a data voltage from the drain electrode 175.

The pixel electrode 191 may include a transparent conductor, such as an indium tin oxide (ITO) or an indium zinc oxide (IZO).

The pixel electrode 191 may include a horizontal stem portion 193 extending in the first direction D1, a vertical stem portion 194 extending in the second direction D2 while crossing the horizontal stem portion 193, and minute branch portions 195 extending in a diagonal direction from the horizontal stem portion 193 and the vertical stem portion 194. In some exemplary embodiments, edges of the minute branch portions 195 may be connected with each other. The pixel electrode 191 includes a protrusion portion 196 that overlaps the drain electrode 175, and may be connected with the drain electrode 175 in the protrusion portion 196.

The pixel electrode 191 may have substantially a quadrangular shape from a plan view. The pixel electrode 191 is divided into a first sub-area Da, a second sub-area Db, a third sub-area Dc, and a fourth sub-area Dd by the horizontal stem portion 193 and the vertical stem portion 194, and includes a plurality of minute branch portions 195 disposed in the respective sub-areas Da to Dd.

Next, an upper panel 200 will be described.

The second substrate 210 is disposed to be overlapped with the first substrate 110 with a predetermined distance therebetween. A light blocking member 220 and a color filter 230 are disposed between a second substrate 210 and a liquid crystal layer 3. The light blocking member 220 is disposed in the upper panel 200 so as to be overlapped with areas where the data line 171 of the lower panel 100 and the transistor are disposed. In the illustrated exemplary embodiment, the light blocking member 220 is included in the upper panel 200, however, the inventive concepts are not limited thereto. For example, in some exemplary embodiments, at least one of the light blocking member 220 and the color filter 230 may be included in the lower panel 100.

An overcoat 250 is disposed between the light blocking member 220 and the color filter 230, and the liquid crystal layer 3. In some exemplary embodiments, the overcoat 250 may be omitted.

A common electrode 270, which is one of the field generating electrodes, is disposed between the overcoat 250 and the liquid crystal layer 3. The common electrode 270 generates an electric field with the pixel electrode 191 of the lower panel 100, such that a direction of liquid crystal molecules 31 of the liquid crystal layer 3 can be determined. In the illustrated exemplary embodiment, the common electrode 270 is disposed in the upper panel 200, however, the inventive concepts are limited thereto. For example, in some exemplary embodiments, the common electrode 270 may be disposed in the lower panel 100.

The liquid crystal layer 3 includes a plurality of liquid crystal molecules 31.

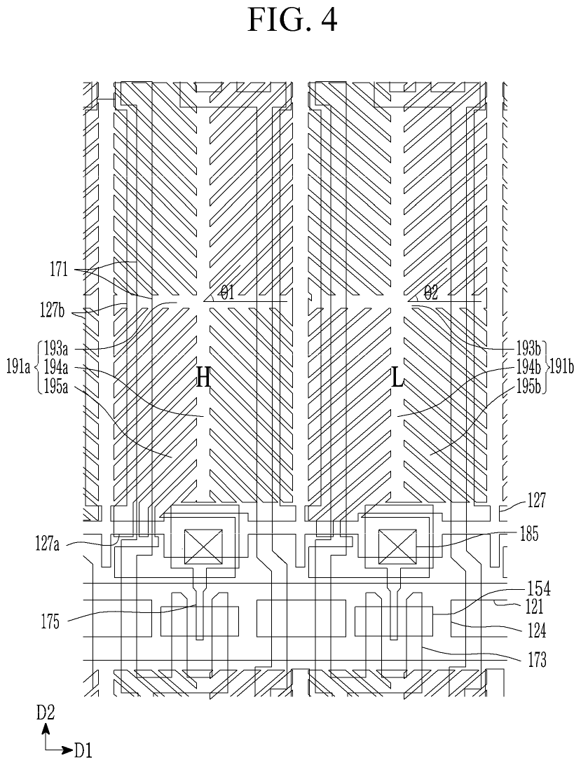

Hereinafter, two pixels adjacent to each other in the first direction D1 will be described with reference to FIG. 4. FIG. 4 is a top plan view of two adjacent pixels in an are B of FIG. 1. The description of substantially the same elements already described above will be omitted to avoid redundancy.

Referring to FIG. 4, the display device according to the illustrated exemplary embodiment may include a first pixel electrode 191a receiving a first voltage and a second pixel electrode 191b receiving a second voltage. The first pixel electrode 191a and the second pixel electrode 191b may be disposed adjacent to each other in the first direction D1.

A planar area occupied by the first pixel electrode 191a and a planar area occupied by the second pixel electrode 191b may be substantially equal to each other. An area ratio of the first pixel electrode 191a and the second pixel electrode 191b may be about 1:1.

The first pixel electrode 191a includes a first horizontal stem portion 193a, a first vertical stem portion 194a that perpendicularly crosses the first horizontal stem portion 193a, and a first minute branch portion 195a that extends in a diagonal direction from the first horizontal stem portion 193a and the first vertical stem portion 194a.

The second pixel electrode 191b includes a second horizontal stem portion 193b, second horizontal stem portion 193b that perpendicularly crosses the second horizontal stem portion 193b, and a second minute branch portion 195b that extends in a diagonal direction from the second horizontal stem portion 193b and the second vertical stem portion 194b.

In the first pixel electrode 191a, the first horizontal stem portion 193a and the first minute branch portion 195a may form a first angle θ1. In the second pixel electrode 191b, the second horizontal stem portion 193b and the second minute branch portion 195b may form a second angle θ2. According to the illustrated exemplary embodiment, the first angle θ1 may be about 38° to about 40°, and the second angle θ2 may be about 41° to about 45°. The first angle θ1 may be smaller than the second angle θ2.

In a relatively low grayscale, side visibility may be greatly influenced by the first pixel H receiving the first voltage. In this case, side visibility at a relatively low grayscale can be improved as an angle formed by the first horizontal stem portion 193a and the first minute branch portion 195a is small.

In addition, as an angle formed by a horizontal stem portion and a minute branch portion is small, transmittance may become low. However, in the second pixel L receiving the second voltage, as an angle formed by the second horizontal stem portion and the second minute branch portion is relatively large, transmittance can be relatively improved.

Since one transistor and one pixel electrode are disposed in one pixel in the display device according to the illustrated exemplary embodiment, a constant level of transmittance can be maintained at high resolution. In addition, since an angle formed by a minute branch portion and a horizontal stem portion in a pixel electrode receiving a relatively high voltage is relatively small, side visibility can be improved. Further, since an angle formed by a minute branch portion and a horizontal stem portion in a pixel electrode receiving a relatively low voltage is relatively large, transmittance can be improved. Accordingly, the display device according to the illustrated exemplary embodiment has an improved display quality at high resolution.

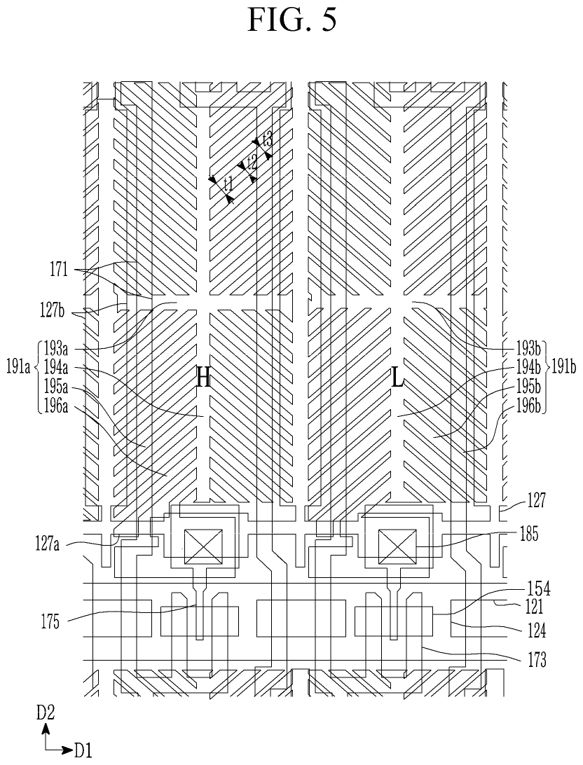

Hereinafter, a display device according to an exemplary embodiment will be described with reference to FIG. 5. FIG. 5 is a top plan view of a portion of a display device according to an exemplary embodiment. The description of substantially the same elements as those described above will be omitted to avoid redundancy.

Referring to FIG. 5, a first pixel electrode 191a includes a first slit 196a disposed between adjacent first minute branch portions 195a. A second pixel electrode 191b includes a second slit 196b disposed between adjacent second minute branch portions 195b.

A width t2 of the first minute branch portion 195a according to the illustrated exemplary embodiment is about 3.0 micrometers to about 3.6 micrometers, and a width t3 of the first slit 196a may be about 2.4 micrometers to about 3.0 micrometers.

A width t2 of the first minute branch portion 195a may be smaller than that of the second minute branch portion 195b. In addition, a width t3 of the first slit 196a may be larger than that of the second slit 196b. For example, the width t2 of the first minute branch portion 195a may be about 3.0 micrometers, and the width t3 of the first slit 196a may be about 3.0 micrometers. In this case, the width of the second minute branch portion 195b may be about 3.6 micrometers, and the width of the second slit 196b may be about 2.4 micrometers.

When the width t2 of the first minute branch portion 195a is smaller than that of the second minute branch portion 195b as in the illustrated exemplary embodiment, side visibility at a low grayscale can be improved.

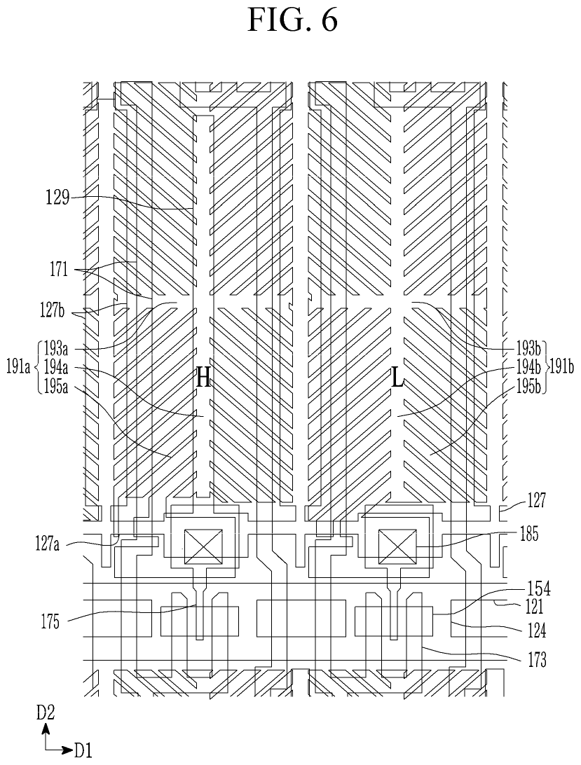

Hereinafter, a display device according to an exemplary embodiment will be described with reference to FIG. 6. FIG. 6 is a top plan view of a portion of a display device according to an exemplary embodiment. The description of substantially the same elements described above will be omitted.

Referring to FIG. 6, a display device according to an exemplary embodiment may further include a light blocking layer 129. The light blocking layer 129 may be disposed on the same layer as the gate line 121, which may be manufactured together through the same process. The light blocking layer 129 may include the same material as the gate line 121.

The light blocking layer 129 according to the illustrated exemplary embodiment may overlap a first vertical stem portion 194a of a first pixel electrode 191a that receives a first voltage. The light blocking layer 129 may extend in the second direction D2. The light blocking layer 129 according to the illustrated exemplary embodiment may have a shape that protrudes from a storage electrode line 127, but the inventive concepts are not limited thereto. For example, in some exemplary embodiments, the light blocking layer 129 may have a shape that is separated from the storage electrode line 127.

A pixel that includes a second pixel electrode 191b that receives a second voltage may not include an additional light blocking layer. As such, a second vertical stem portion 194b of the second pixel electrode 191b may not overlap the light blocking layer.

At a relatively low grayscale, side visibility may be greatly influenced by a first pixel H that receives the first voltage. In particular, side visibility may be deteriorated due to an area that is adjacent to the first vertical stem portion 194a. In the illustrated exemplary embodiment, since the light blocking layer 129 that overlaps the first vertical stem portion 194a is formed, side visibility may be prevented from being deteriorated due to the vertical stem portion, thereby improving display quality of the display device.

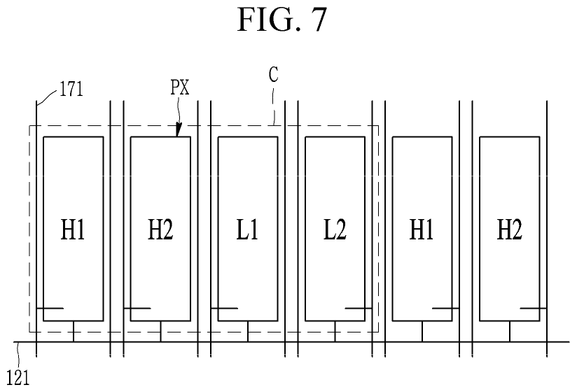

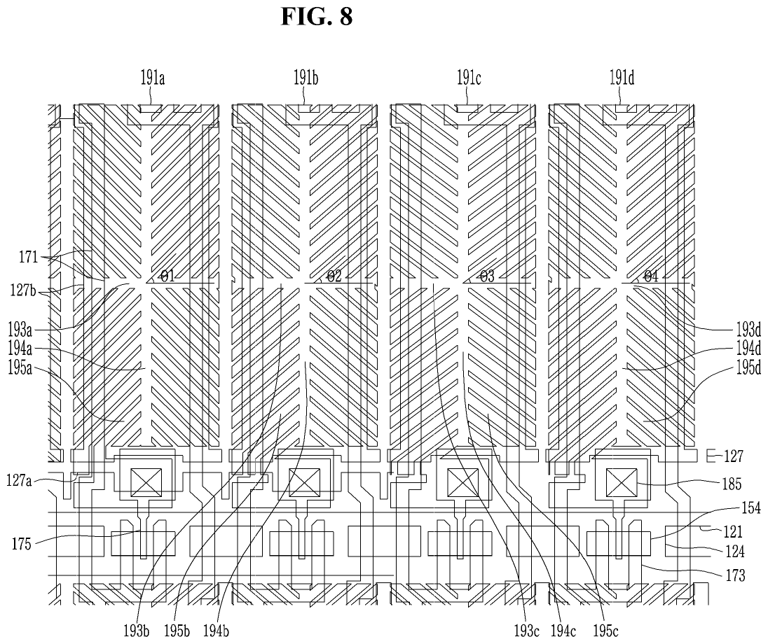

Hereinafter, a display device according to an exemplary embodiment will be described with reference to FIG. 7 and FIG. 8. FIG. 7 is a schematic top plan view of a portion of a display device according to an exemplary embodiment, and FIG. 8 is a top plan view of a plurality of pixels in an area C of FIG. 7.

Referring to FIG. 7 and FIG. 8, a display device according to an exemplary embodiment may include a first pixel electrode 191a that receives a first voltage, a second pixel electrode 191b that receives a second voltage, a third pixel electrode 191c that receives a third voltage, and a fourth pixel electrode 191d that receives a fourth voltage. In the illustrated exemplary embodiment, four pixel electrodes each receiving a different voltage are illustrated, however, the inventive concepts are not limited to a particular number of pixel electrodes receiving different voltages. For example, n number of pixels may each receive a different voltage. In this case, the first voltage, the second voltage, the third voltage, and the fourth voltage may be reduced in order.

In the illustrated exemplary embodiment, the first pixel electrode 191a includes a first horizontal stem portion 193a, a first vertical stem portion 194a that perpendicularly crosses the first horizontal stem portion 193a, and a first minute branch portion 195a that extends in a diagonal direction from the first horizontal stem portion 193a and the first vertical stem portion 194a.

The second pixel electrode 191b includes a second horizontal stem portion 193b, a second vertical stem portion 194b that perpendicularly crosses the second horizontal stem portion 193b, and a second minute branch portion 195b that extends in a diagonal direction from the second horizontal stem portion 193b and the second vertical stem portion 194b.

The third pixel electrode 191c includes a third horizontal stem portion 193c, a third vertical stem portion 194c that perpendicularly crosses the third horizontal stem portion 193c, and a third minute branch portion 195c that extends in a diagonal direction from the third horizontal stem portion 193c and the third vertical stem portion 194c.

The fourth pixel electrode 191d includes a fourth horizontal stem portion 193d, a fourth vertical stem portion 194d that perpendicularly crosses the fourth horizontal stem portion 193d, and a fourth minute branch portion 195d that extends in a diagonal direction from the fourth horizontal stem portion 193d and the fourth vertical stem portion 194d.

In the first pixel electrode 191a, the first horizontal stem portion 193a and the first minute branch portion 195a may form a first angle θ1. In the second pixel electrode 191b, the second horizontal stem portion 193b and the second minute branch portion 195b may form a second angle θ2. In the third pixel electrode 191c, the third horizontal stem portion 193c and the third minute branch portion 195c may form a third angle θ3. In the fourth pixel electrode 191d, the fourth horizontal stem portion 193d and the fourth minute branch portion 195d may form a fourth angle θ4.

According to the illustrated exemplary embodiment, the first angle θ1, the second angle θ2, the third angle θ3, and the fourth angle θ4 may be increased in order. In this case, the first angle θ1 to the fourth angle θ4 may have a value that is gradually increased within a range of about 38° to about 45°.

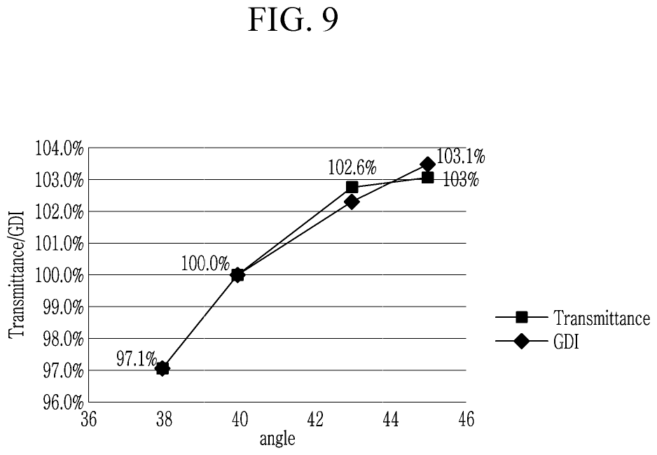

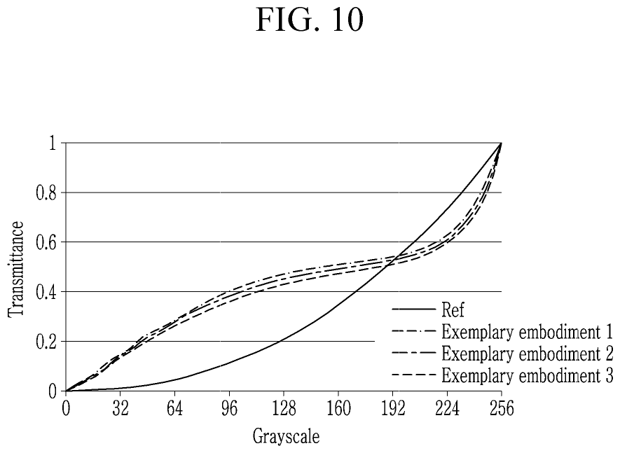

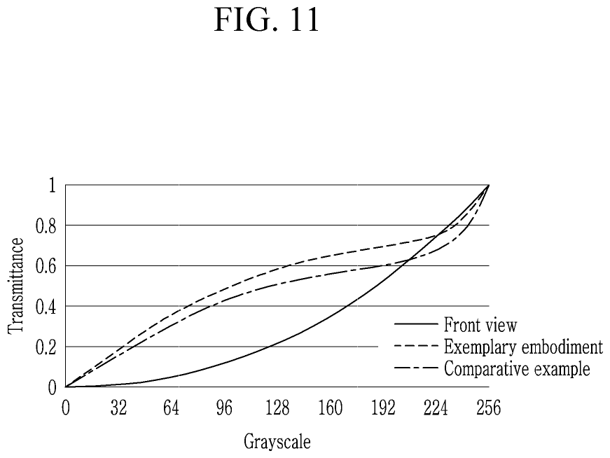

Hereinafter, a display device according to an exemplary embodiment will be described with reference to FIG. 9 to FIG. 11. FIG. 9 is a graph that shows transmittance and GDI according to angles formed by a horizontal stem portion and a minute branch portion, FIG. 10 is a graph showing gamma curves according to grayscales with respect to an exemplary embodiment in which an angle formed by the horizontal stem portion and the minute branch portion varies, and FIG. 11 is a graph showing gamma curves with respect to an exemplary embodiment that includes a light blocking layer and a comparative example.

Referring to FIG. 9, it can be observed that the gamma distortion index (GDI) is increased as an angle formed by a horizontal stem portion and a minute branch portion is increased. When an angle formed by a first horizontal stem portion and a first minute branch portion included in a first pixel electrode is between 38° and to 40°, the GDI may have a relatively low value as in the exemplary embodiment. As the GDI is low, the degree of distortion is low, and thus, the display device exhibits excellent display quality.

In addition, as the angle formed by the horizontal stem portion and the minute branch portion is increased, transmittance is relatively increased. When an angle formed by a second horizontal stem portion and a second minute branch portion included in a second pixel electrode is about 45° according to an exemplary embodiment, transmittance may reach about 103%.

Referring to Table 1, in a comparative example, a first pixel electrode and a second pixel electrode may have the same shape. Table 1 shows transmittance and GDIs when angles between a horizontal stem portion and a minute branch portion of each pixel electrode are 38°, 40°, and 45° according to the comparative example. In addition, the first pixel electrode and the second pixel electrode in the comparative example have different shapes, and transmittance and GDIs when a predetermined voltage is arbitrarily applied, rather than dividing a first voltage and a second voltage respectively to the first pixel electrode and the second pixel electrode as previously described, were observed. In the display device according to an exemplary embodiment, the GDI, which is an index indicating side visibility, was reduced to about 70.6% while maintaining a transmittance level that is similar to that of the comparative example.

TABLE 1

| | | Angle between horizontal stem portion and minute branch portion | | | | |
|---|---|---|---|---|---|---|
| | | First pixel electrode | | | | |
| | | 38° | 40° | 45° | 38° | 40° |
| | | Second pixel electrode | | | | |
| | | | | | 45° | 45° |
| Comparative | Transmittance | 97.4% | 100.0% | 102.5% | 100.0% | 101.3% |
| example | GDI | 97.4% | 100.0% | 103.7% | 100.6% | 101.8% |
| | DELETEDTEXTS | | | | | |
| Exemplary | Transmittance | — | — | — | 100.0% | 101.3% |
| embodiment | GDI | — | — | — | 70.6% | 73.3% |
| | DELETEDTEXTS | | | | | |

Referring to FIG. 9 and Table 1, it can be determined that the display device according to an exemplary embodiment can provide excellent side visibility through an area overlapping a first pixel electrode that is applied with a relatively high voltage, while providing excellent transmittance through an area overlapping a second electrode that is applied with a relatively low voltage.

Next, referring to FIG. 10, angles formed by horizontal stem portions and minute branch portions are reduced in the order of Exemplary Embodiment 1, Exemplary Embodiment 2, and Exemplary Embodiment 3. In this case, it can be determined that side distortion is reduced as the angle between the horizontal stem portion and the minute branch portion becomes smaller in a relatively low grayscale (e.g., a 128 grayscale or less).

FIG. 11 is a graph that shows gamma curves between an exemplary embodiment, in which a light blocking layer overlapping a vertical stem portion is included, and a comparative example, in which a light blocking is not included. Referring to FIG. 11, it can be determined that side distortion is significantly reduced at a low grayscale of 32 grayscale or less in the exemplary embodiment that includes the light blocking layer.

According to the exemplary embodiments, a display device has an improved lateral visibility while maintaining a predetermined transmittance.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a gate line disposed on a substrate;
a first data line and a second line crossing the gate line;
a first transistor electrically connected with the gate line and the first data line;
a second transistor electrically connected with the gate line and the second data line;
a first pixel electrode electrically connected with the first transistor; and
a second pixel electrode electrically connected with the second transistor and overlapping the first pixel electrode along an extension direction of the gate line,
wherein:
the first pixel electrode comprises a first horizontal stem portion, a first vertical stem portion perpendicularly crossing the first horizontal stem portion, and a first minute branch portion extending from the first horizontal stem portion and the first horizontal stem portion;
the second pixel electrode comprises a second horizontal stem portion, a second vertical stem portion perpendicularly crossing the second horizontal stem portion, and a second minute branch portion extending from the second horizontal stem portion and the second vertical stem portion; and
a first angle formed by the first horizontal stem portion and the first minute branch portion is smaller than a second angle formed by the second horizontal stem portion and the second minute branch portion.

2. The display device of claim 1, wherein the first angle is about 38° to about 40°.

3. The display device of claim 1, wherein the second angle is about 41° to about 45°.

4. The display device of claim 1, further comprising a third pixel electrode and a fourth pixel electrode,
wherein:
the third pixel electrode includes a third horizontal stem portion, a third vertical stem portion, and a third minute branch portion;
the fourth pixel electrode includes a fourth horizontal stem portion, a fourth vertical stem portion, and a fourth minute branch portion;
the third horizontal stem portion and the third minute branch portion forms a third angle greater than the second angle; and
the fourth horizontal stem portion and the fourth minute branch portion forms a fourth angle greater than the third angle.

5. The display device of claim 4, wherein:
the first pixel electrode is configured to be applied with a first voltage;
the second pixel electrode is configured to be applied with a second voltage less than the first voltage;
the third pixel electrode is configured to be applied with a third voltage less than the second voltage; and
the fourth pixel electrode is configured to be applied with a fourth electrode less than the third voltage.

6. The display device of claim 1, wherein:
the first pixel electrode is configured to be applied with a first voltage; and
the second pixel electrode is configured to be applied with a second voltage less than the first voltage.

7. The display device of claim 1, wherein an area occupied by the first pixel electrode and an area occupied by the second pixel electrode are substantially the same.

8. The display device of claim 1, further comprising a light blocking layer disposed on the same layer as the gate line and overlapping the first vertical stem portion.

9. The display device of claim 1, wherein:
the first pixel electrode comprises a first slit disposed between the first minute branch portions;
a width of the first minute branch portion is about 3.0 micrometers to about 3.6 micrometers; and
a width of the first slit is about 2.4 micrometers to about 3.0 micrometers.

10. The display device of claim 1, wherein a width of the first minute branch portion is less than a width of the second minute branch portion.

11. A display device comprising:
a gate line disposed on a substrate;
a first data line and a second data line crossing the gate line;
a first transistor electrically connected with the gate line and the first data line;
a second transistor electrically connected with the gate line and the second data line;
a first pixel electrode electrically connected with the first transistor; and
a second pixel electrode electrically connected with the second transistor,
wherein:
the first pixel electrode comprises a first horizontal stem portion, a first vertical stem portion perpendicularly crossing the first horizontal stem portion, and a first minute branch portion extending from the first horizontal stem portion and the first vertical stem portion;
the second pixel electrode comprises a second horizontal stem portion, a second vertical stem portion perpendicularly crossing the second horizontal stem portion, and a second minute branch portion extending from the second horizontal stem portion and the second vertical minute branch portion;
a planar area of the first pixel electrode and a planar area of the second pixel electrode are substantially the same; and
a first angle formed by the first horizontal stem portion and the first minute branch portion is smaller than a second angle formed by the second horizontal stem portion and the second minute branch portion.

12. The display device of claim 11, wherein:
the first pixel electrode is configured to be applied with a first voltage; and
the second pixel electrode is configured to be applied with a second voltage less than the first voltage.

13. The display device of claim 12, wherein the first angle is about 38° to about 40°.

14. The display device of claim 12, wherein the second angle is about 41° to about 45°.

15. The display device of claim 11, further comprising a light blocking layer disposed on the same layer as the gate line and overlapping the first vertical stem portion.

16. The display device of claim 15, wherein the second vertical stem portion does not overlap the light blocking layer.

17. The display device of claim 11, wherein a width of the first minute branch portion is less than a width of the second minute branch portion.

18. The display device of claim 11, wherein:
the first pixel electrode comprises a first slit disposed between the first minute branch portions;
the second pixel electrode comprises a second slit disposed between the second minute branch portions; and
a width of the first slit is greater than a width of the second slit.

19. The display device of claim 11, further comprising a third pixel electrode and a fourth pixel electrode,
wherein:
the third pixel electrode comprises a third horizontal stem portion, a third vertical stem portion, and a third minute branch portion;
the fourth pixel electrode comprises a fourth horizontal stem portion, a fourth vertical stem portion, and a fourth minute branch portion;
the third horizontal stem portion and the third minute branch portion forms a third angle greater than the second angle; and
the fourth horizontal stem portion and the fourth minute branch portion forms a fourth angle greater than the third angle.

20. The display device of claim 19, wherein:
the first pixel electrode is configured to be applied with a first voltage;
the second pixel electrode is configured to be applied with a second voltage less than the first voltage;
the third pixel electrode is configured to be applied with a third voltage less than the second voltage; and
the fourth pixel electrode is configured to be applied with a fourth electrode less than the third voltage.
